(19) United States
(12) Patent Application Publication
(10) Pub. No.: US 2023/0410838 A1
(43) Pub. Date: Dec. 21, 2023

(54) RECORD PRODUCTION DEVICES, SYSTEMS AND METHODS

(71) Applicant: Elasticstage Limited, London (GB)

(72) Inventors: Werner FREISTAETTER, London (GB); Steve RHODES, London (GB)

(21) Appl. No.: 18/242,693

(22) Filed: Sep. 6, 2023

Related U.S. Application Data
(63) Continuation of application No. PCT/GB2022/050584, filed on Mar. 4, 2022.

(30) Foreign Application Priority Data
Mar. 6, 2021 (GB) 2103154.7

(51) Int. Cl. G11B 3/00; G06F 3/16; B29D 17/00

(52) U.S. Cl. CPC G11B 3/008; G06F 3/162; B29D 17/002

(57) ABSTRACT

Methods, system and devices for the production of audio records are provided. A record format is selected, and this selection is used to modify a set of digital audio files. A music production interface may be provided to receive the selection. A set of manufacturing instructions are generated, which are derived from the modified set of digital audio files. The set of manufacturing instructions are used to convert a record blank into a playable audio record.

### CROSS REFERENCE TO RELATED APPLICATIONS

This application is a continuation application under 35 U.S.C. § 120 of International Application PCT/GB2022/050584 filed Mar. 4, 2022, which claims priority to GB Application 2103154.7 filed Mar. 6, 2021, the contents of each being incorporated by reference herein.

### FIELD OF THE INVENTION

The present invention relates to the production of records. In particular, the present invention relates to methods, systems and devices for the production of records, in particular those generally-known as vinyl records, which encode audio information as a spiral groove channelled into a planar disc. The invention also relates to an audio record of a novel construction, made via those methods, systems and devices.

### BACKGROUND TO THE INVENTION

Existing vinyl records are produced by a process involving high temperature and pressure pressing of polyvinyl chloride (PVC). PVC “biscuits” are heated and pressed using a metal stamper to imprint the spiral groove that carries the audio signal. Specifically, a pair of stampers are used to encode two spiral grooves—one for each side of a double-sided record.

Each stamper is contoured with a spiral ridge that is the inverse of the spiral groove set into a respective side of the record. A metal stamper is typically produced via one of two well-known techniques: either a traditional technique, or direct metal mastering.

The traditional technique involves forming a soft master by cutting an audio-signal-modulated groove, using a cutting lathe, into a so-called acetate disc. The acetate disc comprises a smooth lacquer layer that is coated onto, and supported by a rigid underlying aluminium plate. The lacquer layer consists of a relatively soft nitrocellulose material that has physical properties that promotes faithful cutting of the modulated groove without distortion, but is relatively fragile, and unable to itself sustain repeated playback without physical degradation of the information encoded within the groove channelled into the lacquer layer—hence the name “soft master”. Playback, using a playback stylus would physically erode the groove of the soft master. Accordingly, further processing is needed to preserve the information encoded by the groove in a more durable, repeatably-playable format.

To do this, the lacquer layer is coated with a material, such as silver, to turn the layer conductive, and then immersed into a plating bath such that a metal coating forms on the silvered layer: the metal is traditionally nickel or copper. This is separated from the underlying soft master, and so defines an inverted copy of the soft master—termed the “negative” metal master. The soft master is degraded by this process and so must usually be discarded.

Whilst such a negative metal master may in principle be used as a stamper to press a “positive” vinyl copy of the originally cut soft master, repeated stamping results in the eventual degradation of the stamper, putting a limit on the number of copies that can be made with a single metal master. To circumvent this problem multiple additional “negative” stampers can be created via additional electroplating steps: firstly by electroforming a positive metal matrix from the negative metal master, and then secondly electroforming one or more negative stampers from the positive metal matrix. Thus, the traditional technique involves three electroforming steps to obtain each stamper, with the final pressed vinyl record representing a fourth copy of the original soft master.

Direct metal mastering involves cutting directly into a copper plate, and then a single electroforming step to obtain a stamper. The copper plate is more durable, and so can be used to manufacture multiple stampers instead of being discarded like the soft master of the traditional technique. The copper plate must be perfectly flat and smooth to minimise the occurrence of noise when cutting into the audio signal into the plate, and—like the soft master—the underlying plate or substrate must be sufficiently strong and rigid to maintain the flatness and smoothness of copper plate during physically cutting of the audio signal. Warping or flexing of the recording surface will naturally lead to audio distortion.

Under the traditional technique, or direct metal mastering, the audio signal is physically cut into a master “blank” using a cutting stylus of the cutting lathe. The lathe has a heavy turntable to which the master blank is clamped, and maintains a steady rotational speed throughout the cutting operation. The rotational speed corresponds to the intended playback speed of the record.

A central spindle of the turntable extends through a central hole of the master blank. A clamp attaches to the spindle, sandwiching the master blank between it and the turntable. This prevents axial movement along the spindle, and also ensures that the master blank does not undergo rotational movement relative to the turntable. The latter may also be achieved via a second hole, offset from the centre, which receives a cooperating lug extending upwards from the turntable.

The clamp can only extend over and press into the inner central portion of the master blank that immediately surrounds the spindle—i.e. corresponding to the position where the label of a record is normally affixed. This is to prevent interference with the radially outer upper surface into which the audio groove is being cut.

Accordingly, the rigidity of the master blank is of utmost importance to prevent warping. In the traditional technique, as discussed above, this is achieved by having the underlying substrate of the master copy—i.e. underneath the relatively compliant nitrocellulose lacquer layer—constructed of stiff aluminium. Glass has also been known to be used as an underlying substrate. Were it not for this stiffness then the frictional force imparted by the cutting stylus would cause warping of the master copy and so distorting the audio signal.

In other words, the master blank into which the audio signal is recorded via a cutting stylus, is necessarily constructed from two distinct layers: a compliant outer layer that can be easily inscribed into by the cutting stylus, and a stiff inner layer that rigidly supports the outer layer, preventing distortion of the resulting groove that encodes the audio signal. The subsequent steps of electroplating and stamping are then required to preserve the durability of the otherwise fragile groove, and facilitate mass production of records.

Existing vinyl record production thus suffers a number of drawbacks. Electroplating and stamping at high temperatures and pressures are relatively complex and energy intensive processes. Also, the forming of so many intermediate copies between the originally-cut soft master and final playable record can introduce noise.

Attempts have been made to produce stampers using modern technologies, such as via laser engraving, to eliminate electroplating processes and to enhance the resolution of the audio signal inscribed in the final vinyl record. However, the equipment and operating costs of suitable laser machinery is excessive, contributing significantly to the overheads associated with record production.

Accordingly, there is still a high cost of creating records and stampers, regardless of whether the stampers are made via traditional or modern techniques. This necessarily raises the overhead cost of producing each record, making low-quantity production runs of records uneconomical. In other words, all known record-production techniques emphasise mass-production of identical records from stampers to offset the high overhead costs. Low quantity or even “one-off” records, that are of high quality, and durable enough to be played multiple times without signal degradation are simply too expensive.

It is against this background that the present invention has been devised.

### SUMMARY OF THE INVENTION

According to a first aspect of the present invention there may be provided an audio record production system. The system may comprise at least one of: a record manufacturer, and a music production interface. The music production interface may be configured to receive at least one of: a record format selection and a set of digital audio files. The music production interface may be configured to modify the set of digital audio files. The modification may be made in dependence on the record format selection. The music production interface may be configured to generate a set of manufacturing instructions derived from the digital audio files, or modified digital audio files. The music production interface may be configured to transmit the set of manufacturing instructions to the record manufacturer. Preferably, the record manufacturer is configured to receive the set of manufacturing instructions and, in response, convert a record blank into a playable audio record.

Advantageously, the use of a record blank reduces the cost of production of records, especially for low or single quantity orders. This is in contrast with traditional vinyl record production methods which have a large overhead cost, associated with the intermediate stages needed to produce a metal stamper, and which can only be made economically-viable via the mass production of multiple copies of the same record. The use of a record blank cuts out the intermediate stages and the large overhead costs.

The conversion of a record blank into a playable audio record is ideally via a subtractive manufacturing process whereby material is removed from the blank to convert it into a playable record. In particular, the system may comprise a lathe to cut into the blank.

Preferably, the record manufacturer is configured to encode audio within the playable audio record as a modulated spiral groove. The record manufacturer may comprise a cutting head for cutting the groove into the record blank. The record manufacturer may comprise a turntable to which the record blank is temporarily attached during groove formation. Advantageously, this allows relative rotational movement of the cutting head and the blank.

Preferably, the underside surface of the record blank is detachably attached to the turntable during groove formation. Preferably, the majority of the underside surface of the record blank is detachably attached to the turntable during groove formation. Thus, there can advantageously be more than 50% surface area bonding between the turntable and the record blank. More preferably, the surface area bonding is between 75% and 100%.

Preferably, the record blank is attached to the turntable via electrostatic adhesion during groove formation. To this end, the system may further comprise a static generator. The static generator may be configured to generate static for adhering the blank to the turntable via electrostatic adhesion during groove formation. It will be understood that attachment between the turntable and the blank need not necessarily be direct attachment. In particular, for electrostatic adhesion, one or more thin layer may be interposed between the blank and the turntable. Moreover, the system may comprise a support mat, for placement between the turntable and the blank. Advantageously, the support mat help prevent scratches to the underside of the blank and/or improve grip between the blank and the turntable. The turntable may comprise a support mat itself.

The system may further comprises an anti-static device. The anti-static device may be configured to remove the electrostatic adhesion following groove formation, to allow the record formed from the blank to be released from the turntable.

Preferably, the manufacturing instructions comprise pitch speed instruction to control the speed of the radially-inward travel of the cutting head and thereby the pitch of the groove cut into the record.

Preferably, the system further comprises a swarf vacuum for removing swarf from the record. The swarf vacuum may be configured to automatically remove swarf from the record following and/or during cutting of the groove.

Preferably, the record blank is constructed from a plastics material. Preferably, the plastics material is a polyester. The material may be another plastics material having an equivalent or more negative charge on the triboelectric series.

The material from which the blank is constructed may comprise PET-G (i.e. glycol-modified polyethylene terephthalate). The blank may alternatively be constructed from another material having an equivalent hardness. Advantageously, this provides an optimal trade-off between the record blank being easy enough to cut into using a cutting stylus of a cutting lathe, yet be sufficiently resistant to degradation after repeated playback using a traditional record playback stylus.

Preferably, the record blank is constructed from an integral piece of material. Nonetheless, in certain embodiments, the blank may comprise a plurality of layers. Preferably, at least one layer is a plastics material, such as a polyester. Preferably, the plurality of layers are constructed of the same or similar materials. For example, the layers may all be the same or slightly different plastics materials. Advantageously, this facilitates manufacture of the blank, for example, simplifying cohesion of those layers.

Preferably, the blank comprises at least one outer layer, which is cut to encode an audio signal, and an underlying layer, wherein:
the outer layer is constructed from a softer material than the underlying layer;
the underlying layer is constructed from a more rigid material than the outer layer; and/or
the outer layer is translucent, so that the underlying layer is visible beneath it.

Advantageously, a record blank constructed from an integral piece of material simplifies and reduces the cost of manufacturing a record. Nonetheless, a blank constructed from a plurality of layers—which is slightly more complex—can also lead to cost savings: an underlying layer can be constructed from a relatively cheaper and less refined material, whereas the outer layer(s) can be more refined, and chosen for properties allowing faithful and durable encoding of an audio signal cut into the outer layer. Additionally, the underlying layer can be made stiffer to rigidly support the outer layer during cutting.

Preferably, the outer layer is PET-G, and is ideally free of colourant additives. The underlying layer may be PET-A or coloured PET-G, for example. Ideally, the underlying layer contains black colourant—ideally to match existing vinyl records, but may be of any chosen colour. Moreover, if the outer layer is translucent, it is preferred that the underlying layer is opaque. This advantageously, improves the aesthetic of the record product, and also can assist users operating playback equipment to locate, for example, the lead-in groove on to which a playback stylus must be positioned.

It has been determined by the inventors that a greater level of noise is inherent in an audio signal that has been cut into a blank constructed from materials having colourants added to them. This is particularly the case with polyester materials, and PET in particular. Thus, the provision of a translucent outer layer that is free of colourant additives together with an underlying coloured layer allows the benefits of a coloured product to be realised simultaneously with relatively low-noise encoding of the audio signal. This is because the audio signal is cut predominantly into the outer layer.

In any case, as the record blank is not of a traditional construction then the record blank can be made far more economically viable than traditional master discs, such as those used in direct metal mastering, or soft masters used in traditional techniques for the production of records. Furthermore, further steps are not required in order to use the converted record blank as the final playable audio record—the material is durable enough to withstand repeated playback.

The blank may have a thickness of between 0.5 mm and 3 mm. More preferably, the thickness is about 1-2 mm.

Normally, materials having a hardness akin to that of PET-G, and with such thickness ranges would be unsuitable for use as a record blank due to the excessive warping that would be caused during the cutting process. However the present invention overcomes this drawback by minimising flex distortion by adhering the records blank to the underlying rigid turntable.

Advantageously, adhesion is achieved by electrostatically pinning the record to the turntable. The benefits of this approach include the ability to quickly enable and disable the adhesion. Furthermore, electrostatic adhesion does not mar the surface of the record in contact with the turntable, as would be the case with adhesive substances. Additionally, the effectiveness of electrostatic adhesion is not significantly reduced by the presence of a groove already formed on the underside—as typically encountered in the production of a double-sided record.

Accordingly, it is preferable that the record blank has a highly negative or highly positive rating on the triboelectric series. Moreover, it is preferably that the difference in the rating of the turntable and the record blank on the triboelectric series needs to be high.

Preferably, the system further comprises an assembler and/or at least one printing module. The printing module may be configured to receive a set of printing instructions associated with the manufacturing instructions, and in response print packaging for the associated record. Preferably, the record and the packaging are combined together by the assembler to create a music product in the form of combined and distributable records and packaging.

Preferably, the system further comprises a distribution system configured to distribute music products to at least one destination specified in a set of distribution instructions associated with the manufacturing instructions.

Preferably, the manufacturing instructions are associated with at least one of the printing instructions and/or distribution instruction via a unique order identifier.

Preferably, the music production interface comprises an editor configured to receive a user input to specify the appearance of the record and its packaging. The editor may be a WYSIWYG editor. The editor may be configured to receive a user selection and arrangement of image files, and in response generate manufacturing instructions, including printing instructions therefrom.

Preferably, the music production interface is configured to modify the set of digital audio files in response to receiving a user selection of at least one of:
the chronology of the set of digital audio files;
the maximum playback length of the set of digital audio files; and
the playback volume of the set of digital audio files.

Preferably, the music production interface is configured to modify the set of digital audio files by applying at least one filter for controlling the amplitude of predetermined frequencies. At least one applied filter may comprise applying RIAA equalisation.

Preferably, the system further comprises a digital-to-analogue converter for converting the digital audio files to a set of analogue signals. Preferably, the set of analogue signals are a stereophonic pair, each controlling movement, during cutting, of a respective one of a pair of valley walls that define the groove.

Preferably, the system further comprises at least one of: a handling module, an assembler, a printing module, a manufacturing controller, a record distributor, a record manufacturer, a system server, an audio transcoder, an accounts manager, and a user computing device.

Preferably, the system further comprises a server configured to provide the music production interface to a user computing device via a server-client web interface.

According to a second aspect of the present invention there is provided an audio record manufacturer configured and arranged to receive manufacturing instructions that include digital audio files modified in dependence on a selected record format, and in response convert a record blank into a playable audio record.

According to a third aspect of the present invention there is provided an audio record produced by the audio record manufacturer of the second aspect, or the system of the first aspect of the present invention.

According to a fourth aspect of the present invention there is provided a method of producing an audio record. Preferably, the method comprises at least one of:
receiving a record format selection;
modifying a set of digital audio files in dependence on the selected record format;
generating a set of manufacturing instructions derived from the modified set of digital audio files; and
using the set of manufacturing instructions to convert a record blank into a playable audio record.

The method may further comprise at least one of:
transferring digital audio files to a music production interface;
generating production instructions, including transcoded digital audio files;
transmitting production instructions;
manufacturing a record; and
distributing a manufactured record.

It will be understood that features and advantages of different aspects of the present invention may be combined or substituted with one another where context allows.

For example, the features of the system described in relation to the first aspect of the present invention may be provided as part of the manufacturer of the second aspect, the record of the third aspect and/or the method described in relation to the fourth aspect of the present invention.

Furthermore, such features may themselves constitute further aspects of the present invention, either alone or in combination with others. For example, the features of the music production interface, blank, record, cutting lathe, system server, handling module, assembler, printing module, manufacturing controller, record distributor, record manufacturer, audio transcoder, accounts manager, and user computing device may themselves constitute further aspects of the present invention.

### BRIEF DESCRIPTION OF THE DRAWINGS

In order for the invention to be more readily understood, embodiments of the invention will now be described, by way of example only, with reference to the accompanying drawings in which:

FIG. 1 is a schematic block diagram of a record production system according to a first exemplary embodiment of the present invention;

FIG. 2 is a block diagram of a generalised method of producing records; and

FIG. 3 is a schematic view of a record manufacturing and distribution portion of the system of FIG. 1.

### DETAILED DESCRIPTION OF THE PREFERRED EMBODIMENTS

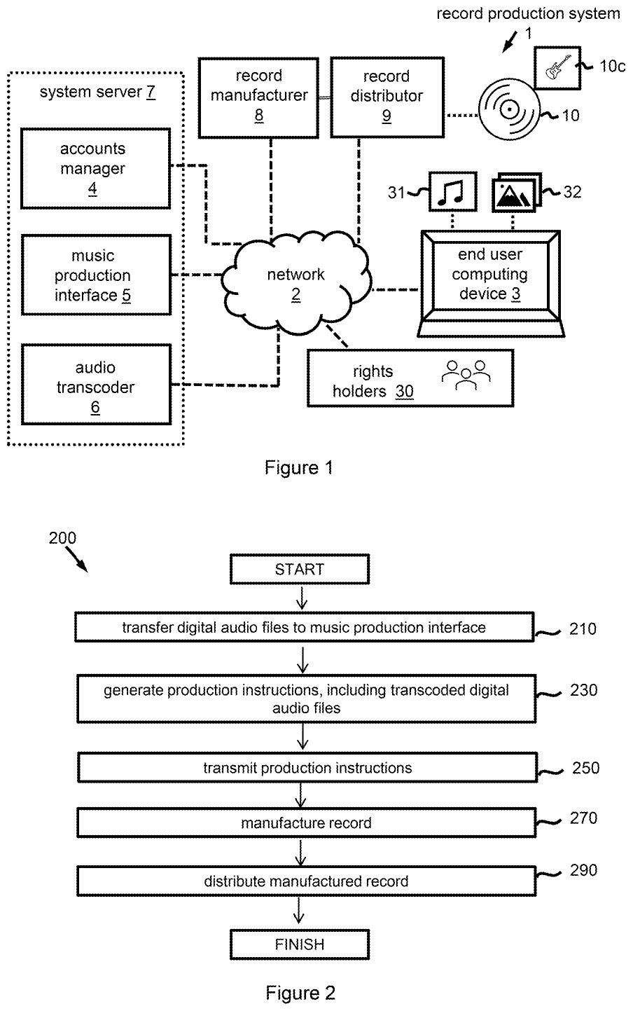

FIG. 1 is a schematic block diagram of a record production system 1 that is configured to implement a method 200 of producing records, a generalised example of which is shown in FIG. 2.

The system 1 comprises a network 2, a user computing device 3, a system server 7, a record manufacturer 8, and a record distributor 9. The system server 7 comprises an accounts manager 4, a music production interface 5, and an audio transcoder 6. The system server 7 also comprises, at least in part, a music platform via which records can be ordered by users of the system 1.

Each user of the system 1 may fall under one or more categories, including ordering users who order records, arranging users who arrange together the songs and artwork that characterise a record, and rights holders who have rights (e.g. copyright or contractual rights) in those songs and artwork. It is entirely possible for a user to fall under all three categories. However, the foregoing example focusses on a user who falls under two of these three categories—as an arranging and ordering user. In this example, the user is envisaged to assemble and submit an order for a so-called “mix-tape” compilation of a selection of songs recorded by other artists. Nonetheless, it will be appreciated that the functionality and arrangement of the system according to various embodiments of the invention applies to scenarios in which different users belong to a different set of categories. The record production system 1 is configured and arranged to allow the user of the user computing device 3 to specify how a music product is created. Specifically, the user can specify the production (i.e. manufacturing and distribution) of a record 10 from a user-selected arrangement of one or more digital audio files 31, via interaction with the music production interface 5 of the server 7. The music production interface 5 also enables the user to produce packaging 10c associated with the record 10 from a user-selected arrangement one or more image files 32. These songs and artwork may not necessarily belong to the user, and so the system 1 is arranged to manage rights held by rights holders 30. In particular, the record production system 1 is arranged to handle royalty payments—which are automatically paid, for example, upon production of a record 10 that features a song (and/or packaging 10c that features artwork) belonging to a respective rights holder 30. Rights holders 30 typically include, for example, image creators, songwriters, recording artists, publishers or even societies that handle royalty payments on behalf of their members—such as the PRS (Performing Rights Society) or MCPS (Mechanical-Copyright Protection Society).

In the present embodiment, the produced record 10 is of a type generally known as a “vinyl” record as discussed in the background section, in which the audio information is physically encoded on the record as an audio-signal-modulated spiral groove. This audio can be subsequently played by a record player, having an audio playback transducer that mechanically interacts with the groove to extract and play the audio information as sound.

Whilst the invention, and the present embodiment is particularly relevant to the production of such records, it should be noted that, in alternative embodiments, the production of other types of media may be supported in addition to, or instead of, vinyl records. In particular, components and aspects of the present embodiment may apply to the production of other physical audio record carriers that use alternative means of physically encoding the audio information—compact discs, for example.

The communications network 2 interconnects the components of the record production system 1 and in various embodiments may be embodied by a wired and/or wireless local area network (LAN), a wide area network (WAN) such as the Internet, or a combination of these. Moreover, certain components of the system 1 shown in FIG. 1 may reside on a single device and so, in this case, the communications network 2 may include intra-device communication channels.

Leading on from this, certain components shown in the schematic block diagram of FIG. 1 may be provided as part of, or otherwise integrated with others.

For example, the record manufacturer 8 and record distributor 9 may be part of a combined manufacturing and production facility. Similarly, the record manufacturer 8 and/or record distributor 9 may comprise at least part of the system server 7. The separation that is schematically shown in FIG. 1 is merely for clarity.

The account manager 4, the music production interface 5, and audio transcoder 6 are shown to be implemented as virtual modules on the system server 7. Whilst the separation in FIG. 1 of these components is shown schematically to illustrate their functional role and relationship, in practice they may each reside in separate devices, or a set of devices, or may be part of one another. For example, the audio transcoder 6 may be part of the music production interface 5.

The music production interface 5 is primarily envisaged to be provided by the server 7 to the user computing device 3 via a server-client web interface. This includes a front-end GUI (graphical user interface) accessed via a web browser. However, in alternative embodiments, the user computing device 3 may be configured to download and execute an independent application which fulfils a set of functions of the music production interface 5.

Moreover, components may not necessarily be in the form of a single physical machine or device. For example, the term “server” may encompass, for example, a distributed or “cloud” computing service, engine, service or platform.

Also, for simplicity and clarity, only single exemplary instances of most components of the system 1 are shown in FIG. 1. Nonetheless, in practice, the record production system 1 typically will include many multiples of various components—for example, at least thousands of user computing devices 3, each with a different user.

FIG. 2 shows an overview of a record production method, as applied by the record production system 1. This allows a user to take on the role of a record producer.

The record production method 200 comprises as a first step 210 transferring digital audio files 31 to the music production interface 5. Image files 32 for use as album art are also typically provided. The audio and image files 31, 32, may be transferred, for example, from the user computing device, via the network 2, to the server 7. Alternatively, or in addition, they may be selected for transfer from a media library separate from the user computing device 3.

The music production interface 5 allows a user, via the user computing device 3, to set preferences that configure the processing of at least one digital audio file 31 so that it can be converted into a form that is desirable and suitable for transfer on to a record 10. Conversion, at least in part, comprises transcoding the digital audio file(s) 31.

The method 200, in a second step 230, comprises generating production instructions on the basis of the processed digital audio files 31. The production instructions include a transcoded version of the digital audio file(s), and typically also the images to be borne by the packaging components of the record 10. Packaging, in the present context refers to labels applied to the record as well as sleeves.

The method 200, in a third step 250 comprises transmitting the production instructions. This is typically from the server 7 to the record manufacturer 8 and the record distributor 9.

The production instructions comprise manufacturing instructions—to be followed by the record manufacturer 8, and distribution instructions to be followed by the record distributor 9. These and other independent parts of the production instructions are linked to or associated with one another via a unique order identifier (UOI). This is so that manufacturing and distribution can be effectively coordinated.

The method 200, in a fourth step 270 comprises manufacturing the record, following manufacturing instructions contained within the production instructions.

The method 200, in a fifth step 290, comprises distributing the manufactured record 10 via the record distributor 9. Notably, the production instructions include distribution instructions such as a dispatch address or destination to which the record 10 is to be sent.

A more detailed description of the system will now be provided with reference back to FIG. 1.

The accounts manager 4 manages a set of user accounts each of which is set up via a registration process. Users, via a suitable computing device 3, access and set up an account with the system server 7 in which they interact with the accounts manager 4 to enter credentials (e.g. username, password, email address) as well as personal details, depending on their intended use of the record production system.

In particular, if a user is an ordering user, and would like to purchase a record for delivery, then details such as payment credentials, and a delivery address is obtained by the accounts manager 4 from the user, and added to their account as a destination for a produced record.

User accounts associated with rights holders 30 can also be managed by the system server 7. In this case, the associated user account may further comprise digital content—such as audio files and/or image files—registered under the account controlled by those users. The account manager 4 allows such users to associate such digital content with their account, for example transferring them to the system server 7 from their computing device or another digital media library. The accounts manager 4 may also store details of a bank account, associated with rights holders 30, so that those rights holders can receive compensation when their rights are used by other users. Accordingly, the system 1 supports the rights management and royalty payment of rights holders 30, such as artists who make their songs available to the system 1.

The account manager 4 also stores data generated by arranging users via their use of the music production interface 5, when those users are logged into their account. This includes preferences, metadata, and arrangements of audio files and artwork.

The music production interface 5 provides a list of physical media formats that are possible for production. An arranging user selects one of those formats, and then selects digital content to be borne by that format, including images to be displayed by packaging, and also audio content to be recorded on the media itself.

Audio and image content that has a rights holder 30 associated with it is registered by the music production interface 5 so that, upon production of the record 10/packaging 10c, a royalty payment will be paid to that rights holder 30.

As discussed, the primarily-envisaged general format is that of a vinyl record 10. However, variations exist under this general format, in terms of the physical size of the record, and also its intended playback speed.

A popular specific format, for which the invention is particularly applicable, is an LP (long play) record. Specifically, this is a double-sided 12 inch record having an intended playback speed of 33.33 rpm (revolutions per minute), utilising the so-called microgroove specification (i.e. read stylus tip having a radius of less than 25 microns; typically in the range 10-20 microns). This will be the example used below. However, in other embodiments, the record may comply with different standards or specifications. For example, another recording and playback speed can be used, with 45 rpm being another popular choice.

Selecting a specific format imposes certain constraints on the reliable production of that record, including the accompanying labelling and packaging.

One constraint is the maximum playback length, which is approximately 20-30 minutes per side for such a 12 inch record. The playback length can vary depending on factors such as the properties of the audio signal itself. Louder, higher amplitude audio signals correspond to broader grooves being cut into each upper and lower side of the record, necessitating large pitch groove spacing to avoid adjacent groove interference. Other properties of the audio signal (e.g. certain frequencies, especially low-frequency components) impose similar constraints on the best way to physically encode that audio signal on a record.

Accordingly, the music production interface 5 allows the arranging user, via the user computing device 3, to set preferences that configure the processing of at least one digital audio file 31 so that it is possible to convert the audio data into a form that is desirable and suitable for transfer on to a record 10.

For example, a set of digital audio files 31 may be transferred to the music production interface 5, and then the ordering of the set of digital audio files 31 can be changed via the music production interface 5 so that the chronology of the audio can be controlled. This is particularly relevant to the compilation of albums, or similar, using distinct songs or tracks.

In addition to this, the music production interface 5 provides feedback to an arranging user about constraints imposed by a record 10 such as the quality and maximum playback length, and allows the arranging user to adjust a compilation accordingly.

The music production interface 5 allows the arranging user to control trade-offs to be made, such as the playback volume versus the total length of compilation. In this example, the music production interface 5 displays each property (e.g. playback volume, length) and its value (e.g. in decibels, and seconds respectively). The music production interface 5 also provides a user-interactable interface element (e.g. a draggable slider) for controlling each property, with user-adjustment of one property leading to an automatic update, via the interface, of the displayed value of the other property. For example, a user dragging a volume slider of the interface 5 to a higher value, will simultaneously cause the interface 5 to automatically display a playback length slider reducing to a lower value.

Preference information user-selected via the music production interface 5 is passed to the audio transcoder 6 to control how the transcoder 6 converts the digital audio files into a form suitable for use by the record manufacturer 8 to produce a record.

Additionally, the audio transcoder 6 applies other treatments to the digital audio files dependent on both the format of the record 10 to be produced, and the composition of the digital audio files.

For example, the transcoder 6 is configured to filter out frequencies in the original digital audio files that are unsuitable for a particular recording format and/or limit the amplitude of other frequencies. Additionally, headroom can be removed to increase the signal-to-noise ratio of the audio data to be encoded, and also peak-limit the audio data.

For example, certain high-amplitude low-frequency bass sounds can pose problems on LP records: the shape of the groove required to encode such sounds is in the form of a “ski-ramp” and so can lead to skipping of the stylus used to read (or even write) the groove. Accordingly, the audio transcoder 6 is configured to minimise the adverse effects of such amplitude/frequency combinations by attenuating them for the LP record format.

The transcoder 6 is configured to apply another similar treatment to the digital audio files in the form of applying RIAA equalisation. Here, the amplitude of low frequencies are globally reduced, and the amplitude of high frequencies are globally boosted according to the standard RIAA equalisation curve for recording. This effectively attenuates high-frequency noises such as hisses and clicks that typically arise during recording.

The transcoder 6 is configured to generate at least part of a set of manufacturing instructions that include transcoded and treated digital audio files: typically a pair of audio files, one for each side of the record 10. Other manufacturing instructions are also generated by the transcoder 6, specific to a particular record format.

Notably, for LP records 10, the transcoder 6 is configured to generate recording pitch speed instructions which control how the rate of radially-inward travel of a cutting stylus varies during manufacture of an LP record 10. Specifically, during recording, the pitch speed controls the pitch of the continuous spiral groove of the LP record, and thus the effective spacing of adjacent grooves.

This is done to achieve a balance between the grooves being too far apart—in which case, the total playback length will be curtailed; and being too close together—in which case groove “collision” may occur. Grooves that are too close together can result in a ghosting effect, where sounds encoded in one groove is undesirably audible via another adjacent groove due to groove wall deformations.

The pitch speed instructions are generated in dependence on the composition of an audio file and the angular velocity of the turntable during playback (and recording). Specifically, the transcoder 6 determines groove widths for the sounds within the digital audio file, and then compares this with groove widths corresponding to sounds occurring a period of revolution apart to determine ideal groove spacing, and so the ideal pitch speed for recording. For example, an LP record intended for playback at 33.33 rpm has a turntable period of one revolution every 1.8 seconds. Thus, audio signals within the digital audio file that are 1.8 seconds apart are compared with one another. Audio signals that will lead to wider grooves (e.g. high amplitude signals) necessitate that the pitch speed is faster during the encoding of these signals and also for the signals that are 1.8 seconds ahead of these signals. Thus, the two grooves adjacent to the intermediate wider groove (i.e. encoding sounds 1.8 second prior, and 1.8 seconds after the high amplitude signals) are sufficiently separated from it.

Manufacturing instructions also originate from the music production interface 5, at least in part.

A WYSIWYG (What You See Is What You Get) editor is provided by the music production interface 5 to allow the arranging user to select the appearance of the record 10 and its packaging 10c. For example, the user may be able to choose the colour of the material from which the record 10 is constructed. Additionally, the user can choose how image files 32 are featured on packaging 10c for the record 10. In the case of an LP record, such packaging typically includes a pair of central record labels—one for each side of the record, and a sleeve.

For example, the user can choose various properties of images (e.g. position, size, coloration, brightness, contrast, opacity) relative to a template which shows the user an outline of the appropriate packaging components. These are displayable via the music production interface 5 relative to other virtual components, such as a virtual record. This provides clear feedback to a user about the sizing of each packaging component. The music production interface 5 provides 2D templates, and 3D model representations of the records and its packaging 10c, further enhancing the user's ability to visualise and control the form of the final music product.

As mentioned, image files 32 may be transferred from the user computing device 3 or from a media library. Furthermore, images may be preloaded into, or automatically-generated by the music production interface 5. For example, standard images, such as a Parental Advisory Explicit logo, may be preloaded into the interface 5, and so immediately available for use without the need for download. Additionally, the music production interface 5 is configured to automatically generate images and/or text specific to music products and their packaging, such as EAN-13, Grid and ISRC codes. The music production interface 5 can automatically generate such codes on the basis of information provided by the user—for example, the country of origin. Furthermore, the music production interface 5 comprises a barcode generator for generating barcodes from such alphanumeric codes—thereby representing such alphanumeric codes graphically such that they are more readily machine-readable. The music production interface 5 can also automatically-generate metadata associated with record and packaging arrangements.

Accordingly, an arranging user can define a set of music products by choosing arrangements of music and artwork to be applied to relevant music formats. These music products can be ordered by the same user, acting as an ordering user.

Furthermore, these music products can be made available for other ordering users to order by the arranging user publishing those music products on the music platform supported by the system server 7. To this end, user accounts, as managed by the accounts manager 4, allow an arranging user to define a publicly-accessible set of information relating to music products, including a user-specified type and extent of access to those products. For example, the user accounts manager 4 allows an arranging user to specify which music products are available for others to order, and in which formats. One music product may be available for order as only an LP record, for example. Additionally, the accounts manager 4 allows the arranging user (and in many cases, rights holders 30) to specify options and information such as:
whether aspects of those music products can be previewed online (e.g. music preview of certain music tracks);
search terms to allow discovery of those music products;
track listings;
track/album play length;
composer listings;
video clips;
copyright information; and
artwork presentation.

Some information, such as track/album play length, may be automatically generated by the music production interface 5, for example, from the metadata generated during interaction of the arranging user with the music production interface 5.

This information is published on the music platform such that ordering users can order records arranged by arranging users, which in turn feature content generated by rights holders.

Thus, an ordering user can submit an order for the production of a record 10 specified by the arranging user. In response, the system server 7 generates production instructions that include the manufacturing instructions generated by the transcoder 6 and music production interface 5 as well as other data associated with a music product.

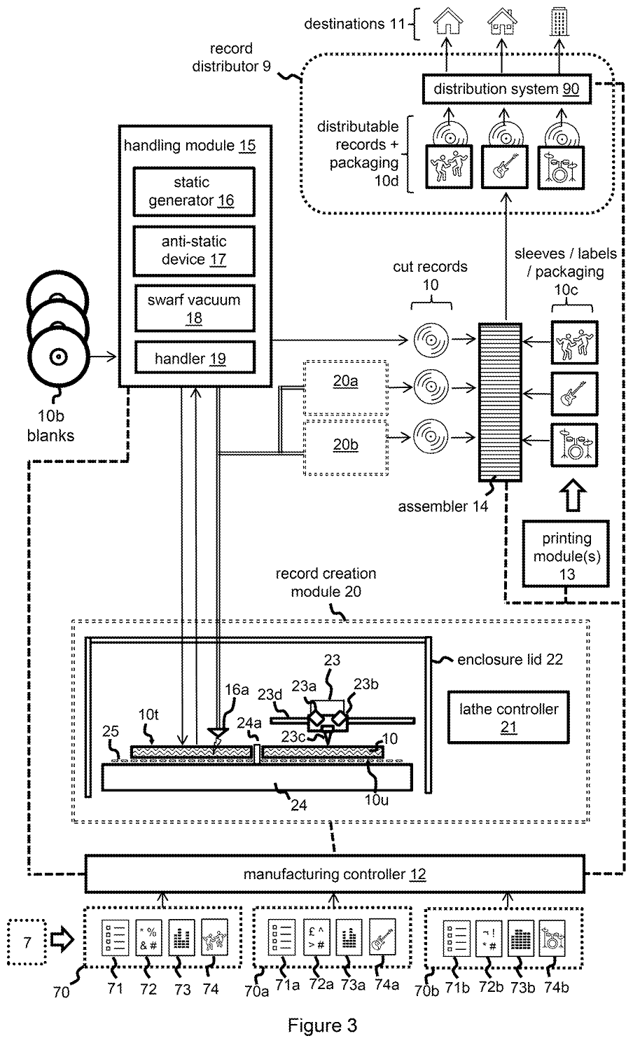

FIG. 3 is a schematic block diagram of a record manufacturer 8 and record distributor 9, the components of which are configured and arranged to receive orders—that include production instructions 70—via the network 2 from the system server 7, and then manufacture and distribute music products.

The production instructions 70 include distribution instructions 71 to allow the music product to be distributed to an appropriate destination 11. The production instructions 70 also include a unique order identifier (UOI) 72 and manufacturing instructions containing transcoded audio files 73 and printing instructions 74. Several sets of production instructions 70a, 70b and respective distribution instructions 71a, 71b, UOIs 72a, 72b and manufacturing instructions 73a/74a, 73b/74b may be sent to the record manufacturer 8 simultaneously.

The record manufacturer 8 comprises a manufacturing controller 12, printing modules 13, an assembler 14, and a handling module 15. The handling module 15 comprises a static generator 16, an anti-static device 17, a swarf vacuum 18, and a handler 19. The record distributor 9 comprises a distribution system 90. The static generator 16 is connected to static pins within each record creation module 20, 20a, 20b. One static pin 16a is shown within the record creation module 20 of FIG. 3.

In the present embodiment, the manufacturing controller 12 receives the production instructions 70 from the system server 7 and distributes the various components of the production instructions 70 to the appropriate parts of the record manufacturer 8, or the record distributor 9 to allow an order to be fulfilled. For example, the distribution instructions 71, 71a, 71b are sent to the distribution system 90 by the manufacturing controller 12.

However, in other embodiments, the system server 7 may send the various components of the production instructions 70 directly to each respective component. For example, the system server 7 may send the distribution instructions 71, 71a, 71b directly to the distribution system 90. Alternatively, the manufacturing controller 12 may itself reside on the system server 7, at least in part.

In any case UOIs 72, 72a, 72b are sent to each component of record manufacturer 8 and record distributor 9 to allow the different instructions to be associated with one another by a common order number. This allows the various outputs of the components of the record manufacturer 8 and the record distributor 9 to be married with one another for the effective fulfilment of an order.

The record manufacturer 8 also comprises a set of record creation modules 20, 20a, 20b. Each record creation module 20, 20a, 20b is identical, and so the specific details of only one are shown and will be described for brevity.

Record creation module 20 comprises a lathe controller 21, an enclosure lid 22 and a cutting head 23 that includes transducers 23a, 23b, a diamond cutting stylus 23c and a carriage 23d. The record creation module 20 further comprises an aluminium turntable 24 arranged to support, and centrally-register via a spindle 24a of the turntable 24, a record 10 into which an audio-modulated groove can be cut using the cutting head 23. The turntable 24 comprises an upper surface which supports an underside 10u of the record 10, whilst the cutting stylus 23c cuts into the top-side 10t of the record 10. The record creation module 20 further comprises a rubber support mat 25 sandwiched between the underside 10u of the record 10 and the upper surface of the turntable 24.

The record creation module 20 may comprise a standard swarf vacuum and vacuum tube in addition to or instead of the swarf vacuum 18 of the handling module.

Other features common in the art to record lathes are also present, but not explicitly described or shown in FIG. 3.

The manufacturing controller 12 is communicatively connected to the record creation modules 20, 20a, 20b, the handling module 15, the printing modules 13, the assembler 14 as well as the distribution system 90. As mentioned, the manufacturing controller 12 receives the production instructions 70 and sends each component an appropriate set of instructions. Transmission of instructions to each component may be performed in accordance with a schedule determined by the manufacturing controller 12 in order to efficiently queue or otherwise manage the production of music products.

In particular, manufacturing instructions are sent to the handling module 15 and record creation module 20, printing instructions 74 are sent to the printing module 13, UOIs are sent to the assembler 14.

The handling module 15 is configured to receive manufacturing instructions, and in response handles an appropriate record blank 10b into position within one of the record creation modules 20, 20a, 20b. The handling module 15 retains the blank 10b in position during a groove cutting process, retrieves the cut record 10 and passes it to the assembler 14. Manufacturing instructions 73 include characteristics of the record 10 to be produced (e.g. size and colour) and thus the appropriate blank 10b is chosen by the handling module 15 in response to receiving these characteristics within the manufacturing instructions 73.

Printing instructions 74, 74a, 74b, are transmitted to the printing modules 13 which print, cut and otherwise prepare sleeves, labels and/or other packaging 10c which are likewise passed to the assembler 14. The assembler 14 receives cut records 10 and their packaging 10c, and via the UOIs (or via scheduling or other means) marries the appropriate cut record 10 with its packaging 10c to output to the record distributor 9 a set of music products in the form of distributable records and packaging 10d. The distribution system 90 of the record distributor 9 then sends those music products to the destinations 11 specified by the appropriate distribution instructions 71, 71a, 71b. The UOIs may be represented in machine-readable format, such as barcodes, printed or otherwise applied to each component to be assembled together by the assembler 14.

The advantageous manufacture of a specific LP record will now be described.

This is made from a blank constructed from an integral piece of plastics material. Specifically the plastics material is polyethylene terephthalate modified with glycol (PET-G), the resulting composition being advantageous for the process as will be described. This composition can be coloured to virtually any desirable colour, including black to match the colour of traditional vinyl records. Thus, the record 10 of the present embodiment is not made from vinyl (PVC), even if it is referred to generally as a “vinyl record”.

In alternatives, the blank may be constructed from a plastics material that comprises several layers. In particular, the blank may comprise two outer layers, and an underlying layer between them, the outer layer each being cut into to encode a respective audio signal. In certain alternatives, the outer layers are constructed from a softer and less rigid material than the underlying layer. Also, the outer layers are translucent whereas the underlying layer is coloured. Whilst a multi-layer construction is more complex than a blank constructed from an integral piece of plastics material, it can lead to certain advantages as detailed above.

In response to receiving an order, the manufacturing controller 12 directs the handling module 15 to retrieve a blank 10b and place it on the turntable 24 of the record creation module 20. This is performed by the handler 19—which in the present embodiment is a robot handler 19. In alternative embodiments, this part of the process may be carried out manually. The rubber support mat 25 is already in place on the turntable 24, and defines a thin protective layer between the underside of the blank 10b and the turntable 24—which could otherwise scratch the blank 10b.

The handling module 15 then initiates fixing of the blank 10c to the turntable 24. In existing record lathes, this is achieved via a clamp applied to the spindle of the turntable that traps a central part of the disc between it and the turntable. Alternatively, vacuum pinning can be used to adhere a disc to the turntable. However, in the present embodiment, this is advantageously achieved by electrostatic adhesion between the turntable 24 and the blank 10c.

This is achieved via the handling module 15 having a static generator 16 that connects via a high DC voltage line to a static discharging pin 16a within the record creation module 20. These are activated to carry approximately 5-25 kV to the pin 16a. The pin 16a is positioned in close proximity to the turntable 24—typically 1-3 cm away from it, near the peripheral edge of the blank 10b. Corona discharge from the pin 16a passes across the blank 10b and the thin rubber support mat 25 to the turntable 24 which is grounded, or otherwise connected back to the static generator 16 via another voltage line of opposite polarity to that connected to the pin 16a.

In the described embodiment, a set of discharge pins—at least one within each record creation module 20, 20a, 20b—is provided so that a single static generator can serve multiple record creation modules 20, 20a, 20b. However, in alternatives to this embodiment, there is one static generator dedicated to each record creation module. Also in certain alternatives embodiments, the discharging pins can be mounted either onto the handling module 15, or on to the/each record creation module 16.

The turntable 24 is constructed of aluminium and the blank 10c is constructed from PET-G, and so these two materials are widely spaced on the triboelectric series, with aluminium being positive and the PET-G being highly negative. Accordingly, the application of electrostatic charge causes these two materials to be strongly attracted to one another. Thus the blank 10c can be held securely to the turntable 24 without the need for a traditional clamp.

The rubber support mat 25 is sufficiently thin (˜0.5 mm) so that the electrostatic adhesion between the turntable 24 and the blank 10b is not significantly impacted. The inventors have discovered, through experimentation, that an optimal material to use for the mat 25 is a synthetic rubber having a relatively high density (>1600 kg per cubic metre). In particular, the mat is constructed from a fluoropolymer elastomer that ideally has a fluorine content of approximately between 65-70%—typically sold under the brand name Viton™. Such a material ensures that the support mat 25 is thin yet durable, prevents scratching, and promotes electrostatic adhesion. Additionally, the mat 25 does not significantly compress under the forces generated by the cutting head 23 and electrostatic adhesion. Accordingly, groove cutting is more reliable.

Using electrostatic force to bind the blank 10b in place firstly simplifies the handling process to place the blank 10b on to the turntable 24—as no clamp need be fitted. Secondly, it also ensures a more reliable and distributed connection across substantially the entire surface area of the underside 10u of the record/blank 10b that is bears against the turntable 24 via the mat 25.

The electrostatic adhesion also restrains against relative rotational movement between the turntable 24 and blank 10b about the spindle, removing the need for a second offset hole to be formed in the blank 10b as is often found on traditional record mastering arrangements. The mat 25 also prevents rotational slippage, gripping both the turntable 24 and the blank 10b.

This represents a significant advantage over traditional disc adhesion methods. Vacuum-based methods introduce vibrational noise to the turntable to which the disc is held. Additionally, traditional clamping methods fix only the central inner part of a disc, and so the surrounding part of the disc into which the groove is cut can flex, in theory, relative to the centre. Existing prejudices in this technical field do not recognise this as a significant problem for traditional mastering arrangements, as mastering discs are multi-layered, including a highly stiff layer to minimise such flexing distortion. However, the present embodiment of the invention removes the possibility of such flex. This, in turn, allows relatively simple, inexpensive, thin, compliant blanks 10b to be used.

The blank 10b is approximately 1-2 mm in thickness. In other embodiments, the thickness typically ranges from 0.5 mm to 3 mm. The use of such relatively thin blanks 10b—which would otherwise be too prone to flex—are made possible via the advantageous electroadhesion method of clamping the blanks 10b.

Following placement by the handler 19 of the blank 10b on to the turntable 24 of the record creation module 20, the enclosure lid 22 is lowered. This acts as a safety mechanism preventing an operator from coming into contact with the high voltages required to operate the discharging pin 16a. The enclosure lid 22 also sound-insulates the interior of the record creation module 20, which minimises external vibrational interference with the cutting head 23 which may otherwise be detrimental to faithful recording.

The enclosure lid 22 may comprise a switch mechanism that disables the high-voltage connection from the static generator 16 to the discharging pin 16a when the lid 22 is open, and conversely enables the high-voltage connection to the discharging pin 16a when the lid 22 is closed. In certain embodiments, the discharging pin 16a is physically coupled to the lid 22 such that lifting the lid 22 separates the pin 16a away from the blank 10b (or record 10), and conversely lowering the lid 22 precisely positions the pin 16a an optimal distance away from the blank 10b and turntable 24.

The handling module 15 and the lathe controller 21 are coordinated with one another—for example via the manufacturing controller 12—so that once a blank 10b has been placed into position on the turntable 24, the lid 22 is closed, and the blank 10b held in place by electroadhesion, to start the groove-cutting process.

The lathe controller 21 receives the appropriate manufacturing instructions 73 that include transcoded audio files from the manufacturing controller, and this is used to drive the operation of the cutting head 23, including the groove-cutting modulation performed by the transducers 23a, 23b. The lathe controller 21 may receive the transcoded audio files in digital format, and convert them into a stereophonic pair of analogue signals to be sent to each respective transducer 23a, 23b.

Alternatively, the lathe controller 21 may receive such signals from an intermediate digital-to-analogue converter. As a further alternative, the digital-to-analogue converter may be part of the music production interface 5.

The lathe controller 21 also controls radially-inward travel of the cutting head 23 along the carriage 23d at pitch speeds set by the manufacturing instructions 73. The turntable 24 rotates at a regular angular velocity of 33.33 rpm and the cutting stylus 23c cuts a spiral audio-modulated groove into the blank 10b corresponding to the transcoded audio file within the manufacturing instructions 73.

As is well-known in the art of record production, the groove, in section, defines a V-shaped valley, having left and right valley walls corresponding to left and right channels of a stereophonic audio signal. The valley walls are inclined at 90 degrees to one another, and degrees relative to an axis normal to the generally planar surface of the record. Likewise, left and right transducers 23a, 23b are positioned and arranged to move the cutting stylus 23c along respective orthogonal planes during cutting, transducer-caused vibration of the stylus 23c corresponding to the signal to be encoded.

The process of cutting a spiral audio-modulated groove into a record 10 typically takes 15-20 minutes to complete for each side of the record 10. During this period, the discharging pin 16a repeatedly and periodically emits a static charge to keep the blank 10b adhered to the turntable 24. From experimentation, approximately 4-10 discharge cycles, lasting a few seconds each, 2-5 minutes apart are sufficient to keep the blank 10b securely adhered to the turntable. Using a duty cycle like this allows the output from the static generator 16 to be distributed sequentially to discharging pins of each record creation module 20, 20a, 20b in turn without a loss of power or efficacy of electroadhesion. Thus one static generator can serve multiple record creation modules for certain embodiments.

Also from experimentation, the inventors have determined an optimal discharging regime in which relatively high-voltage power is applied before the cutting head 23 is engaged with the blank 10b, and a relatively low-voltage power is applied during engagement of the cutting head 23 with the blank 10b, during groove cutting. The high-voltage power is preferably two or more times higher than the lower-voltage power. This reduces the chance of electricity from the discharging pins arcing to or otherwise interfering with the operation of the cutting head 23.

Specifically, prior to groove cutting, a voltage of approximately 17 kV is applied by the electrostatic generator, and thereafter, during groove cutting, regular applications of 7 kV are provided to top-up the electrostatic adhesion established prior to cutting.

During this groove-cutting period, the handling module 15 is free to service other record creation modules 20a, 20b, and so is efficiently utilised in what would otherwise be a period of inactivity.

Following the completion of the cutting process at the record creation module 20, the handling module 15 returns. The anti-static device 17 is enabled to disable the electroadhesion between the cut record 10 and the turntable 24.

The anti-static device 17 comprises an ioniser bar and transformer. An input voltage is increased by a transformer to around 7.5 kV. This is carried by a shielded high-voltage cable to the ioniser bar of the anti-static device 17, where it is connected to an array of emitter electrodes. This creates a high-energy ion cloud, in which a very large number of positive and negative ions are generated. Both positive and negative ions are produced in approximately equal quantities. A statically-charged surface of either polarity passing close to this ion cloud will be quickly neutralised. The anti-static device 17 is positioned to direct the ion cloud towards the cut record 10 and turntable 24, cancelling out the effects of electroadhesion. An example of a suitable anti-static device 17 is a short-range pulsed 24V input DC ionising device. However, other anti-static devices—AC or DC—can be used to similar effect.

Additionally, in certain alternative embodiments, the anti-static device 17 or its emitter electrodes may be part of the record creation module(s) instead of the handling module 15.

Following the action of the anti-static device 17, the swarf vacuum 18 of the handling module 15 is able to clean any residual swarf away. The robot handler 19 may then flip the record 10 to repeat a groove cutting process on the other side using a second transcoded audio file included within the manufacturing instructions 73. Alternatively, if this has been done already, or is not required, then the robot handler removes the cut record 10 and passes it to the assembler 14 for combination with appropriate packaging 10c.

In the present embodiment, the ionising anti-static device 17 are mounted to the robot handler 19, such that deionisation and manipulation of the cut record 10 can be performed contemporaneously. However, in alternative embodiments, these components may be independent, and their functions may be carried out independently.

As mentioned above, the assembler 14 receives and combines cut records 10 and their packaging 10c, outputting to the record distributor 9 a set of music products in the form of distributable records and packaging 10d. The distribution system 90 of the record distributor 9 typically inserts these into a mailing envelope bearing the address of the destinations 11 specified in the original order, and submits these envelopes to a mailing system for delivery.

The record distributor 9 communicates dispatch of music products to the system server 7. This allows the server 7 to notify an ordering user of dispatch, and also carry out a royalty transaction, rewarding the rights holders 30 whose audio and/or image works are borne by the record 10 and/or packaging 10d.

Accordingly, an enhanced record production system 1 and method 200 can be realised, in particular for LP records, that supports economically-viable small-unit music products. Thus, an industry which previously supported only high-quantity units from relatively few artists can be opened up to a large number of artists having relatively few number of produced units.

Although the invention has been described in conjunction with specific embodiments thereof, it is evident that many alternatives, modifications and variations will be apparent to those skilled in the art.

Accordingly, it is intended to embrace all such alternatives, modifications and variations that fall within the scope of the appended claims.

We claim:

1. An audio record production system (1), comprising:
a record manufacturer (8); and
a music production interface (5) configured to:
receive a record format selection and a set of digital audio files (31);
modify the set of digital audio files (31) in dependence on the selected record format;
generate a set of manufacturing instructions (73) derived from the modified set of digital audio files; and
transmit the set of manufacturing instructions (73) to the record manufacturer (8);
wherein the record manufacturer (8) is configured to receive the set of manufacturing instructions (73) from the music production interface (5) and, in response, convert a record blank (10b) into a playable audio record (10).

2. The system (1) of claim 1, wherein conversion of a record blank (10b) into a playable audio record (10) is a subtractive manufacturing process whereby material is removed from the blank (10b) to convert it into the playable audio record (10).

3. The system of claim 1, wherein the record manufacturer (8) is configured to encode audio within the playable audio record as a modulated spiral groove;
wherein the record manufacturer (8) comprises a cutting head (23) for cutting the groove into the record blank (10b), and a turntable (24) to which the record blank 10b is temporarily attached during groove formation, to allow relative rotational movement of the cutting head (23) and the blank (10b).

4. The system (1) of claim 3, wherein the underside surface of the record blank (10b) is detachably attached to the turntable (24) during groove formation.

5. The system (1) of claim 4, wherein a majority of the underside surface of the record blank (10b) is detachably attached to the turntable (24) during groove formation.

6. The system (1) of claim 4, wherein the record blank (10b) is attached to the turntable (24) via electrostatic adhesion during groove formation;
wherein the system further comprises a static generator 16 configured to generate static for adhering the blank 10b to the turntable 24 via electrostatic adhesion during groove formation; and
wherein the system further comprises an anti-static device (17) configured to remove the electrostatic adhesion following groove formation, to allow the record (10) formed from the blank (10b) to be released from the turntable (24).

7. The system (1) of claim 3, wherein the manufacturing instructions (73) comprise pitch speed instruction to control the speed of the radially-inward travel of the cutting head (23) and thereby the pitch of the groove cut into the record (10).

8. The system (1) of claim 3, further comprising a swarf vacuum for automatically removing swarf from the record (10) following or during cutting of the groove.

9. The system (1) of claim 1, wherein the record blank (10b) is constructed from a plastics material.

10. The system (1) of claim 9, wherein the plastics material is at least one of: a polyester and a plastics material having an equivalent or more negative charge on the triboelectric series to polyester.

11. The system (1) of claim 10, wherein the record blank (10b) is constructed from at least one of:
an integral piece of material; and
a plurality of layers constructed from similar plastics materials.

12. The system (1) of claim 9, wherein the material comprises PET-G.

13. The system (1) of claim 1, wherein the blank (10b) has a thickness of between 0.5 mm and 3 mm.

14. The system (1) of claim 1, further comprising:
an assembler (14) and at least one printing module (13), the printing module (13) configured to receive a set of printing instructions (74) associated with the manufacturing instructions (73), and in response print packaging (10c) for the associated record (10), the record (10) and the packaging (10c) being combined together by the assembler (14) to create a music product in the form of combined and distributable records and packaging (10d); and
a distribution system (90) configured to distribute music products to at least one destination (11) specified in a set of distribution instructions (71) associated with the manufacturing instructions (73); wherein
the manufacturing instructions (73) are associated with at least one of the printing instructions (74) and distribution instruction (71) via a unique order identifier (72); and
wherein the music production interface (5) comprises an editor configured to receive a user input to specify the appearance of the record (10) and its packaging (10c), the editor being configured to receive a user selection and arrangement of image files (31), and in response generate manufacturing instructions, including printing instructions (74) therefrom.

15. The system (1) of claim 1, wherein the music production interface (5) is configured to modify the set of digital audio files in response to receiving a user selection of at least one of:
the chronology of the set of digital audio files;
the maximum playback length of the set of digital audio files; and
the playback volume of the set of digital audio files.

16. The system (1) of claim 1, wherein the music production interface (5) is configured to modify the set of digital audio files by applying at least one filter for controlling the amplitude of predetermined frequencies;
wherein at least one filter applied comprises applying RIAA equalisation.

17. The system (1) of claim 1, further comprising a digital-to-analogue converter for converting the digital audio files to a set of analogue signals;
wherein the set of analogue signals are a stereophonic pair, each controlling movement, during cutting, of a respective one of a pair of valley walls that define the groove.

18. The system (1) of claim 1, further comprising at least one of:
a handling module (15), an assembler 14, a printing module (13), a manufacturing controller (12), a record distributor (9), a record manufacturer (8), an audio transcoder (6), an accounts manager (4), a user computing device (3), and server (7) configured to provide the music production interface (5) to a user computing device (3) via a server-client web interface.

19. An audio record produced by an audio record manufacturer (8), the audio record manufacturer (8) being configured and arranged to receive manufacturing instructions (73) that include digital audio files modified in dependence on a selected record format, and in response convert a record blank (10b) into a playable audio record 10.

20. A method of producing an audio record, the method comprising:
receiving a record format selection;
modifying a set of digital audio files (31) in dependence on the selected record format;
generating a set of manufacturing instructions (73) derived from the modified set of digital audio files; and
using the set of manufacturing instructions (73) to convert a record blank (10b) into a playable audio record (10).
